(19) United States
(12) Patent Application Publication
(10) Pub. No.: US 2003/0058111 A1
(43) Pub. Date: Mar. 27, 2003

(54) Computer vision based elderly care monitoring system

(75) Inventors: Mi-Suen Lee, Ossining, NY (US); Miroslav Trajkovic, Ossining, NY (US); Serhan Dagtas, Little Rock, AR (US); Srinivas Gutta, Yorktown Heights, NY (US); Tomas Brodsky, Croton-on-Hudson, NY (US); Vasanth Philomin, Hopewell Junction, NY (US); Yun-Ting Lin, Ossining, NY (US); Hugo Strubbe, Yorktown Heights, NY (US); Eric Cohen-Solal, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/189,272

(22) Filed: Jul. 3, 2002

Related U.S. Application Data
(60) Provisional application No. 60/325,399, filed on Sep. 27, 2001.

(51) Int. Cl. G08B 23/00

(52) U.S. Cl. 340/573.1; 348/77; 348/154; 382/100

(57) ABSTRACT

A method for monitoring a person of interest in a scene, the method comprising: capturing image data of the scene; detecting and tracking the person of interest in the image data; analyzing features of the person of interest; and detecting at least one of an event and behavior associated with the detected person of interest based on the features; and informing a third party of the at least one detected events and behavior.

### CROSS REFERENCE TO RELATED APPLICATIONS

This application claims the benefit of earlier filed provisional application Ser. No. 60/325,399 filed Sep. 27, 2001, the contents of which is incorporated by its reference.

### BACKGROUND OF THE INVENTION

1. Field of the Invention

The present invention relates generally to computer vision, and more particularly, to a computer vision based elderly care monitoring system.

2. Prior Art

Monitoring systems based on cameras have become popular in the security field. The input from many cameras is analyzed by computers for “suspicious events”. If such an event occurs, an alarm is raised and a human operator takes over who can contact building personnel, security officers, local police, etc. These systems were originally deployed only in stores and warehouses, but are now beginning to become available for home use as well.

In the United States, there are currently 40 million elderly (i.e. over the age of 65). Eleven million of them live alone, and about a quarter of these require some monitoring for emergencies such as having a heart attack or a bad fall. Frequent monitoring by health professionals is done in nursing homes and assisted living facilities. However, there is only space for a fraction of the elderly in these facilities. Moreover, these facilities are often prohibitively expensive, and unpopular, as they displace the elderly from their homes.

Universities and industrial laboratories are currently investigating vision-based solutions for intelligent environments, but very few target home applications. Among them, MIT's Oxygen Project aims at creating environments/spaces where computation is ubiquitous and perceptual technologies (including vision) are an integral part of the system. The EasyLiving project in Microsoft Research uses computer vision to determine the location and identity of people in a room, to be used in applications that aid everyday tasks in indoor spaces.

Researchers at the Georgia Institute of Technology are building the “Aware Home” as a test environment for smart and aware spaces that use a variety of sensing technologies, including computer vision. One of their initiatives called “Aging in Place” also deals with elderly care monitoring. However, the “Aging in Place” system uses a “Smart Floor”, which consists of force-sensitive load tiles that can locate and identify a person based solely on his or her footsteps. Installation of such a system in an existing home is not only disruptive, but also costly, making the system inaccessible to many elderly.

### SUMMARY OF THE INVENTION

Therefore it is an object of the present invention to provide a elderly care monitoring system, that overcome the disadvantages associated with the prior art.

Accordingly, a method for monitoring a person of interest in a scene is provided. The method comprises: capturing image data of the scene; detecting and tracking the person of interest in the image data; analyzing features of the person of interest; and detecting at least one of an event and behavior associated with the detected person of interest based on the features; and informing a third party of the at least one detected events and behavior. The person of interest is preferably selected from a group comprising an elderly person, a physically handicapped person, and a mentally challenged person. The scene is preferably a residence of the person of interest. The detecting of at least one of an event and behavior preferably detects at least one of an abnormal event and abnormal behavior.

Preferably, the detecting and tracking comprises segmenting the image data into at least one moving object and background objects, the at least one moving object being the object of interest. The detecting and tracking preferably further comprises: learning and recognizing a human shape; and detecting a feature of the moving object indicative of a person. Preferably, the detecting of a feature of the moving object indicative of a person comprises detecting a face on the moving object.

The detecting of abnormal events preferably comprises: comparing the analyzed features with predetermined criteria indicative of a specific event; and determining whether the specific event has occurred based on the comparison. The specific event is preferably selected from a group comprising a fall-down, stagger, and panic gesturing. Preferably, the analyzing comprises analyzing one or more of a temporal sequence of the person of interest, a motion characteristics of the person of interest, and a trajectory of the person of interest. The determining step preferably comprises assigning a factor indicative of how well each of the analyzed features comply with the predetermined criteria indicative of the specific event and applying a arithmetic expression to the factors to determine a likelihood that the specific event has occurred.

The detecting of abnormal events preferably comprises modeling a plurality of sample abnormal events and comparing each of the plurality of sample abnormal events to a sequence of the image data.

The detecting of abnormal behavior preferably comprises; computing a level of body motion of the person of interest based on the detected tracking of the person of interest; computing a probability density for modeling the person of interest's behavior; developing a knowledge-based description of predetermined normal behaviors and recognizing them from the probability density; and detecting the absence of the normal behaviors.

Preferably, the informing comprises sending a message to the third party that at least one of the abnormal event and abnormal behavior has occurred. The sending preferably comprises generating an alarm signal and transmitting the alarm signal to a central monitoring station. Alternatively, the sending comprises transmitting at least a portion of the captured image data to the third person.

Also provided is a system for monitoring a person of interest in a scene. The system comprises: at least one camera for capturing image data of the scene; a processor operatively connected for input of the image data for: and detecting and tracking the person of interest in the image data; analyzing features of the person of interest; detecting at least one of an event and behavior associated with the detected person of interest based on the features; and informing a third party of the at least one detected event and behavior.

Still yet provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a general schematic of the system of the present invention.

FIG. 2 illustrates a schematic showing an interaction between the modules of FIG. 1.

FIG. 3 illustrates a more detailed schematic of the segmentation and tracking and object classification modules of FIG. 1.

FIG. 4 illustrates a hierarchy of classification classes used in a preferred implementation of the classification of humans and/or objects in the image data.

FIG. 5 illustrates an exemplary hierarchical HMM topology for use in the learning of events module of FIG. 1.

### DETAILED DESCRIPTION OF THE PREFERRED EMBODIMENT

Although this invention is applicable to numerous and various types of monitoring systems, it has been found particularly useful in the environment of elderly care. Therefore, without limiting the applicability of the invention to elderly care, the invention will be described in such environment. The method and system of the present invention is equally applicable to similar classes of people, such as the physically handicapped and mentally challenged.

The method and system of the present invention extend current security systems in at least three ways to make them suitable for monitoring certain classes of people, such as the elderly. First, the system tracks a person in a house in greater detail than in a security monitoring system, where the mere presence of a person is cause for an alarm. The system preferably uses several cameras per room and combines information from the various views; it distinguishes between a person, a pet and things like moving curtains; it determines the trajectory through the house of the person; it determines the body posture, at least in terms of sitting/standing/lying; and it determines a level of body motion.

Second, the notion of “suspicious event”, used by security systems, is replaced with the notion of “medical emergency event.” In particular, events are looked for that would prevent a person from calling for help him or herself. Such events are referred to generally as “abnormal events.” Falling is a main abnormal event, in particular if it is not soon followed by getting up. It might be due to slipping, fainting, etc. Examples of other observable abnormal events are: a period of remaining motionless, staggering, and wild (panic) gestures. The latter can also be a visual way of calling for help. Although there are many more classes of medical events, techniques similar to those described herein are used to detect such events. Further, although the methods and systems of the present invention have particular utility to the detection of abnormal events and abnormal behavior, those skilled in the art will appreciate that other events which may not be considered abnormal can also be detected, such as running and exiting.

Third, the system and methods of the present invention preferably have a strong implicit learning means, with which they will learn “normal behavior patterns” of the person. Deviation from these patterns is considered abnormal behavior and can be an indication of an emergency, e.g. going to lie on the bed at an unusual time, due to nausea, having a heart attack, etc., not taking the dog for a walk, not going to the kitchen for food, sitting up all night or moving around more slowly. All significant deviations will be logged for further analysis by the system and made available to a remote individual, such as a health care professional, for assessment and/or used to generate an alarm.

An automatic monitoring system, such as the system of the present invention, installed in the home of the elderly would alleviate the problems associated with the prior art: it continuously checks on them and, if a problem arises, sends an alarm to a family member or a service organization, who could then dispatch medical help. Alternatively, either a message or the image data from the cameras 102 can be sent to a third person, such as a medical professional, for an independent assessment. As such, it is a natural extension of today's home security systems. For these reasons, those skilled in the art will appreciate that the methods and system of the present invention have great economic and psychological benefits.

In general, the system of the present invention has the following preferred features:

It is camera-based, since a system that need not be attached to the body (non-intrusive) has the largest potential for gaining acceptance by the elderly; it preferably uses multiple cameras per room.

It keeps track of the actions of at least one person in a house in which cats or dogs may also be present. The tracking of more than one person in a home adds some complexity to the system. In such a system it is necessary to have a means for distinguishing between the different people in the home, such as a facial recognition system, the operation of which is well known in the art.

It detects when a person of interest 1) staggers, 2) falls, 3) remains motionless for a certain time, or 4) makes wild (panic) gestures.

It notices abnormal behavior with respect to movement through the house (e.g. going to lie on the bed at an unusual time; no trips to the kitchen; sitting up all night).

It logs all activities for further analysis. The decision whether to raise an alarm can be made artificially or left to medical and/or or other professionals.

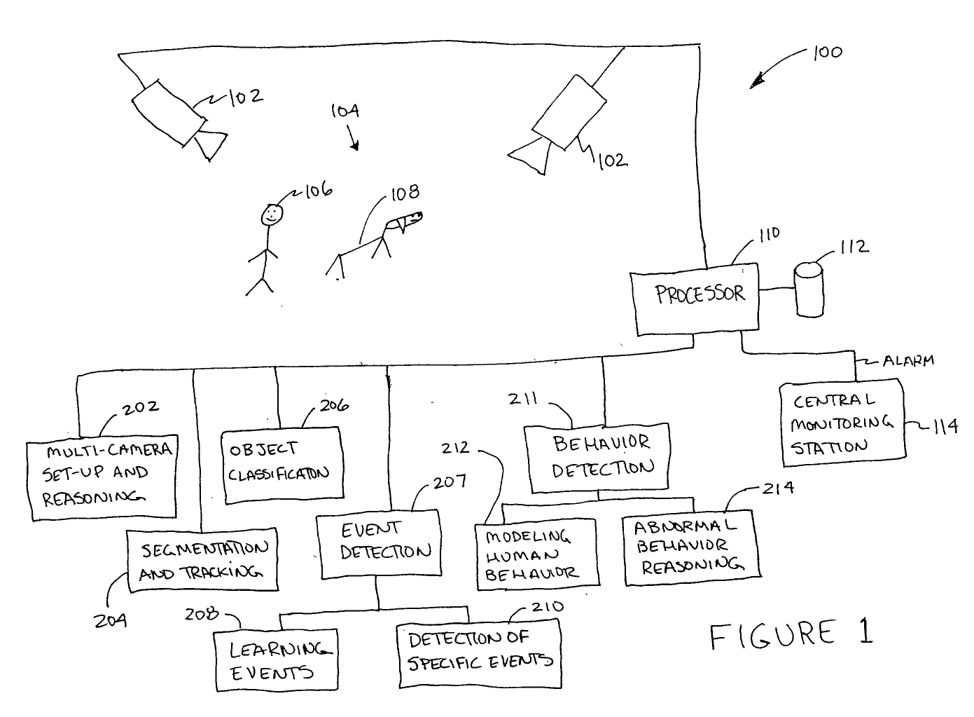

An overview of an apparatus for carrying out the methods of the present invention will now be described with reference to FIG. 1, the apparatus being generally referred to by reference numeral 100. The apparatus 100 comprises at least one camera 102. Although a single camera 102 can be used in the methods and apparatus of the present invention, information from multiple cameras 102, when available, is preferably combined and events derived from multiple views. The cameras 102 are preferably fixed but may also be capable of panning, tilting, and zooming, the control of which is well known in the art. Furthermore, it is preferred that the cameras 102 are video cameras and capture digital video image data of a scene 104, such as a room, including objects therein, such as humans 106, pets 108, and other objects (not shown). However, analog cameras 102 may also be used if their output is converted to a digital format for further use in the methods of the present invention.

The output from the cameras 102 input a processor 110, having a memory 112 operatively connected thereto. The processor 110 preferably has several modules operatively connected thereto for carrying out the tasks associated with the methods of the present invention. Each of the modules is preferably in the form of a set of instructions for carrying out their corresponding tasks. The modules are used to help detect the occurrence of events and abnormal behavior, the results of which can be the basis for alerting others of a possible problem, such as a medical emergency. The alarm can take many forms, such as a telephone call to a medical emergency professional, a relative, or a remote central monitoring station 114. The alarm can be a signal that indicates a possible problem with the person 106 of interest or it may be the transmission of the output of one or more of the cameras 102, such as to a medical professional who can make an independent analysis.

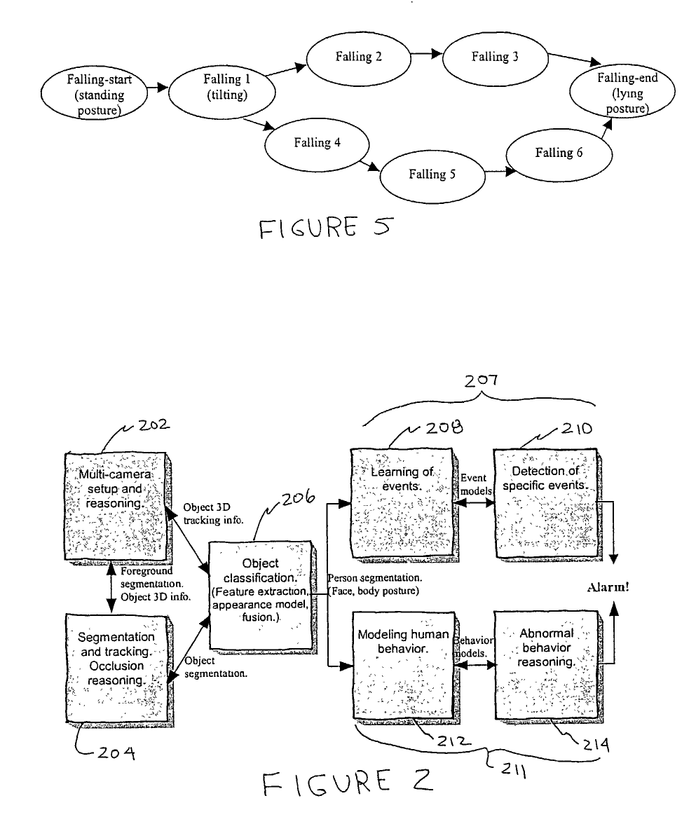

Each of the modules of the monitoring system 100 preferably has a specific function in the system 100. The preferred interactions between the modules are depicted in FIG. 2. It is typically difficult to monitor an entire room 104 with one camera 102. Therefore, as discussed above with regard to FIG. 1, several stationary cameras 102 are utilized and placed at different locations in the room 104. The set-up of the cameras 102 is shown schematically at module 202, which is also responsible for multi-camera reasoning. For each camera 102, a background model is built to facilitate the fast segmentation of foreground and background. Once foreground pixels are identified, image segmentation and grouping techniques are applied at module 204 to obtain a set of foreground regions. Each region is then classified as a human 106, a pet 108, or an object (not shown) at module 206. This classification preferably handles partial body occlusions and non-upright body poses. Position tracking is then used at module 204 to keep track of the location of every person. The level of body motion is also determined.

Multi-camera reasoning is applied at module 202 to combine the foreground information from the various cameras 102. Camera calibration is typically needed to provide the reference frame in which observations from various view angles are integrated. Foreground regions extracted from individual camera viewpoint are mapped to the reference frame. When more than one observation of a human or an object is available, three-dimensional information is inferred, which is then used for classifying the region at module 206. If it is determined that the classified region is a person 106, or a particular person of interest, the image data corresponding thereto is analyzed for detection of certain events at module 207 and/or behavior at module 211 which may be cause for an alarm or further analysis by a human operator. Module 207 preferably detects events by learning events at module 208 and/or detection of specific predefined events at module 210. Module 211 preferably detects behavior by modeling human behavior at module 212 and/or detecting abnormal behavior at module 214. The preferred methods for carrying out the functions of the modules will be discussed in detail below.

Segmentation and Tracking

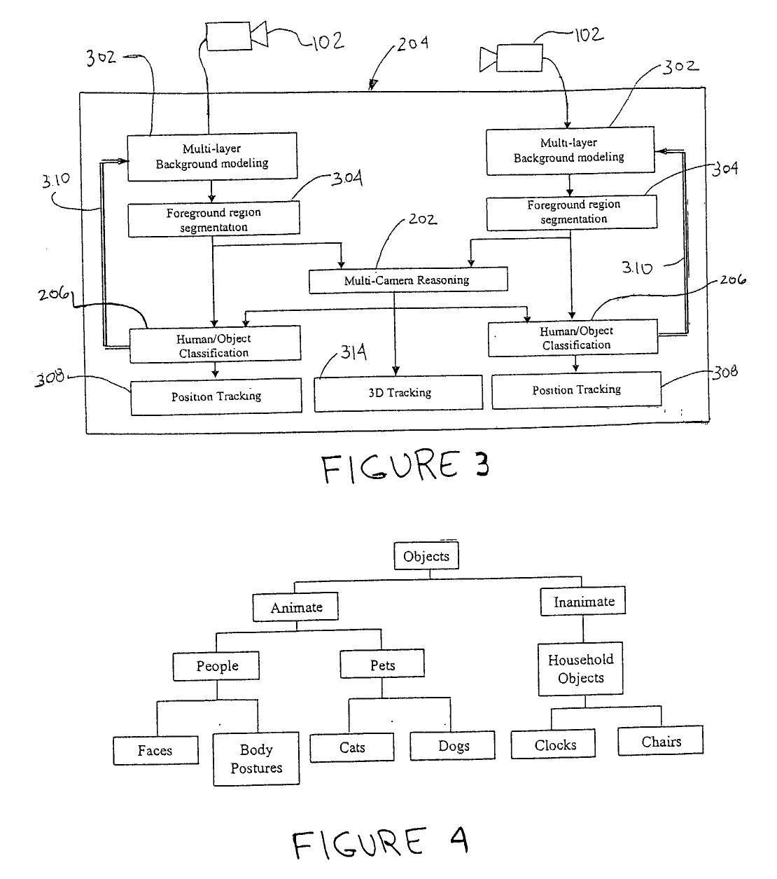

Referring first to FIG. 3, after image data has been captured for a particular scene, relevant objects have to be extracted from raw video. The extraction of relevant objects from the image data preferably involves two processes: segmentation locates objects of interest in individual images, and tracking follows the objects across images. In the preferred implementation of the methods and apparatus of the present invention, the primary objects of interest are humans. However, those skilled in the art will appreciate that other objects may also be of interest, such as objects that people interact with, such as pets and furniture.

Segmentation detects people in the image data scene, for example using a method called background subtraction, which segments the parts of the image corresponding to moving objects. Tracking tracks the regions in the image. Real-time detection of humans typically involves either foreground matching or background subtraction. Foreground matching is well known in the art, such as that disclosed in Gavrila et al., Real-time Object Detection for Smart Vehicles, Proc. International Conf. on Computer Vision, I:87-93, 1999. Background subtraction is also well known in the art, such as that disclosed in Wren et al., Real-time tracking of the human body, IEEE Trans., Pattern Analysis and Machine Intelligence, 19(7), 780-785, 1997. Human shapes can be detected directly by some form of template matching, such as the techniques disclosed in Gavrila et al. (supra) and Oren et al., Pedestrian detection using wavelet templates, Proc. IEEE Conf. on Computer Vision and Pattern Recognition, pp. 193-199, 1997 for the detection of pedestrians in front of moving cameras. Humans can also be detected in image data by the detection of characteristics unique to humans, such as facial features and skin tones. Facial detection of humans is well known in the art, such as that disclosed in Turk et al., Eigenfaces for recognition, J. of Cognitive Neuroscience, 3(1): 71-86, 1991 and Bartlett et al., Independent component representations for face recognition, In Proc. of SPIE—Conference on Human Vision and Electronic Imaging, 2399:528-539,1998.

When stationary cameras 102 are used, segmentation of objects of interest is usually obtained by background subtraction. First, a statistical model of the background is constructed at sub-module 302 for each camera 102. Then, foreground regions are detected at sub-module 304 by marking pixels that do not match the model (see Wren et al., supra). The extracted foreground regions are further analyzed to distinguish between people and other objects at sub-module 306, and also to fit body parts to the regions. Background subtraction methods that can properly handle many different variations in the background, such as moving curtains, flickering TV screens, or changes in illumination are well known in the art, such as that disclosed in Elgammal et al., Non-Parametric Model for Background Subtraction, Proc. European Conf. on Computer Vision, 2000; Stauffer et al., Adaptive Background Mixture Models for Real-Time Tracking, Proc. IEEE Conf. on Computer Vision and Pattern Recognition, II: 246-252, 1999; and Horprasert et al., A Statistical Approach for Real-time Robust Background Subtraction and Shadow Detection, Proc. Frame-Rate Workshop, 1999.

After the humans (or other objects of interest) are identified in the image data for the scene, the human is tracked throughout the scene at sub-module 308. In many real-time systems that detect humans in every video frame, the tracking process is rather simple. Objects detected in successive frames are assumed to be the same if their corresponding image regions overlap. To deal with occlusions, more sophisticated methods that use shape, color, and intensity information have been developed, such as that disclosed in Darrell et al., Integrated Person Tracking Using Stereo, Color, and Pattern Detection, Intl. J Computer Vision, 37(2): 175-185, June 2000 and Isard et al., A Bayesian Multiple-Blob Tracker, Proc. Intl. Conf. Computer Vision, II: 34-41, 2001.

As discussed above, FIG. 3 presents an overview of the segmentation and tracking module 204 and its interaction with the object classification and multi camera reasoning modules 206, 208. It is typically difficult to monitor an entire room (scene) with a single camera 102. Therefore, it is preferred that several stationary cameras 102 be placed at different locations. The cameras 102 are preferably positioned and oriented in such a way that they provide multiple views for the central part of each room (scene), but only a single view for the rest (such as corners). For each camera 102, a background model is built at sub-module 302 to facilitate the fast segmentation of foreground and background. In order to handle large moveable background objects, the background model is preferably modified to contain multiple-layers, so as to capture various states of the background. Previously, layered representations have mostly been used in motion segmentation, such as that disclosed in Weiss, Smoothness in Layers: motion segmentation using nonparametric mixture estimation, Proc. Conf. Computer Vision and Pattern Recognition, pp. 520-526, 1997; or in foreground tracking, such as that disclosed in Tao et al., Dynamic Layer Representation with Applications to Tracking, Proc. Conf. Computer Vision and Pattern Recognition, II: 134-141, 2000.

By maintaining layers in the background, pixel statistics can efficiently be transferred when a background object moves. To deal with local deformations of things such as furniture surfaces, a local search is added to the process of background subtraction. Once foreground pixels are identified, image segmentation and grouping techniques are applied at sub-module 304 to obtain a set of foreground regions. Each region is then classified as a human, a pet, or an object at module 206, using the classification process described below. The classification preferably handles partial body occlusions and non-upright body poses. Pixels in object regions are then updated accordingly in the background model by signal 310. Simple position tracking is preferably used at sub-module 308, because the identities of individual people are usually not needed.

If more than one camera 102 is utilized, multi-camera reasoning is applied at module 202 to combine foreground information from the various cameras 102. Camera calibration is preferably used to provide the reference frame in which observations from various view angles are integrated. Foreground regions extracted from individual camera viewpoint are mapped to the reference frame. When more than one observation of a human or an object is available, three-dimensional information is inferred at sub-module 314, which is then used for classifying the region.

Object Classification

The classification of humans and/or other objects in the image data performed at module 206 will now be discussed in detail. The ability to differentiate among objects is fundamental for efficient functioning of the methods of the present invention. Examples of these objects include animate objects like people 106 and pets 108 and in-animate objects like doors, chairs, etc. The methods of the present invention preferably use a hierarchical scheme for generic object recognition based on Time-Delay Neural Networks (TDNN). The use of TDNN for recognition is well known in the art, such as that disclosed in Looney, Pattern Recognition Using Neural Networks, Oxford University Press, Oxford, 1997. Object recognition using computer vision is also well known in the art, such as that disclosed in Duda et al., Pattern Recognition and Scene Analysis, Wiley, N.Y. 1973; Chin et al., Model-based recognition in robot vision, ACM Computing Surveys, 18(1): 67-108, March 1986; and Besl et al., Three-dimensional object recognition, Computing Surveys, 17(1): 75-145, March 1985.

Appearance based techniques have been extensively used for object recognition because of their inherent ability to exploit image based information. They attempt to recognize objects by finding the best match between a two-dimensional image representation of the object appearance against prototypes stored in memory. Appearance based methods in general make use of a lower dimensional subspace of the higher dimensional representation memory for the purpose of comparison. Common examples of appearance based techniques include Principle Component Analysis (PCA), Independent Component Analysis (ICA), Neural Networks, etc.

In a preferred implementation of the methods and apparatus of the present invention, a generic object is represented in terms of a spatio-temporal gradient feature vector of its appearance space. The feature vectors of semantically related objects are combined to construct an appearance space of the categories. This is based on the notion that construction of the appearance space using multiple views of an object is equivalent to that of using the feature vectors of the appearance space of each of that object. For animate objects the feature vectors are constructed for the face space, since face information provides an accurate way to differentiate between people and other objects. Furthermore, the body posture of the individual under consideration is modeled, since for event detection and behavior analysis it is important to ascertain if the person is sitting or standing.

Instead of directly using image information, gradients are preferably used as a means for building the feature vectors. Since objects are preferably classified under various poses and illumination conditions, it would be non-trivial to model the entire space that the instances of a certain object class occupy given the fact that instances of the same class may look very different from each other (e.g. people wearing different clothes). Instead, features that do not change much under these different scenarios are identified and modeled. The gradient is one such feature since it reduces the dimension of the object space drastically by only capturing the shape information. Therefore, horizontal, vertical and combined gradients are extracted from the input intensity image and used as the feature vectors. A gradient based appearance model is then learned for the classes that are to be classified, preferably using an Elman recurrent neural network, such as that disclosed in Looney (supra).

Once the model is learned, recognition then involves traversing the non-linear state-space model, used in the Elman recurrent neural network, to ascertain the overall identity by finding out the number of states matched in that model space.

Thus, in summary, the preferred approach for object classification is as follows. Given a collection of sequences of a set of model objects, horizontal, vertical and combined gradients are extracted for each object and a set of image vectors corresponding to each object is formed. A recurrent network is built on each such set of image vectors and a hierarchy of appearance classes is constructed using the information about categories. The higher levels of the hierarchy are formed by repeatedly combining classes, as shown in FIG. 4. Given a sequence of the unknown object, the recognition error is computed with respect to the highest class. The recognition error with respect to all nodes is then computed at its intermediate lower level. If the recognition error at the next level is higher than the recognition error at the current level, then the method stops, otherwise, the method proceeds to the node which has the lowest recognition error, for which the recognition error computations are repeated.

Event Detection

Detection of events is one of the several capabilities of the monitoring system 100 of the present invention. Among many events that can be extracted from image data, preferably video image data, there is preferably a focus on abnormal events that may indicate a medical emergency, such as the following events:

Fall-down: For some elderly, any fall should be reported even when the person gets up right after the fall.

Fall-down not followed by Get-up: This indicates that the person has been injured during the fall, or is suffering from a serious medical problem.

Staggering: This event may precede a fall or indicate a health problem.

Wild (panic) gestures: This event provides a simple means of communication. The monitored person can signal a problem, e.g., by quickly waving their arms.

Person being motionless over an extended period of time: This event indicates possibly serious medical problem.

These events are preferably detected by event detector module 207 using event detectors specifically designed for the chosen events as disclosed in co-pending application serial no. ______, (attorney docket no. 702865), the disclosure of which is incorporated herein by its reference, or using a general framework that learns and detects any event from a sufficient number of examples, such as that described below.

### Detection Of Specific Events

Referring back to FIG. 2, the specific event detection is shown as module 210 for the analysis of the person of interest 106 detected and tracked in the image data and for the detection of a specific event relating to the person of interest 106. The input to the specific event detection module 210 is both the video sequence from the cameras 102 (from module 202), plus the output of the segmentation and tracking and object classification modules 204, 206 which specify for each detected object its position in the image (e.g., the center of mass), the bounding box (the bounding rectangle around the object), or the exact shape of the region corresponding to the object. This information is preferably updated in every frame as the person moves around the scene (e.g., room 104).

As discussed above, several specific events of interest are preferably selected, such as “fall down” or “stagger” and a specific event detection module 210 is preferably provided for each such event. However, for purposes of this disclosure, it is assumed that a specific single event, such as a fall-down has been selected as the event of interest. The goal of the specific event detector module 210 is to process the data received from the tracking and segmentation and object classification modules 204, 206, extract more information, as needed, from the input image date (module 202), and to detect instances of when the specific event of interest happens. When the specific event of interest is detected, the information is preferably passed on to a control module (not shown), for further processing, such as notifying the central monitoring station 114.

As mentioned above, additional features are preferably extracted from the image data and/or from the tracking data. The specific event detector module 210 scans the computed features and searches for specific predetermined criteria (e.g., patterns) indicating the specific event of interest. For example, for the fall-down event, the specific event detector module 210 preferably searches for temporal sequence(s), motion characteristics, and/or trajectories that are predetermined to be indicative of a fall-down event.

With regard to the temporal sequence, the specific event detector module 210 preferably looks for a transition in the tracked object of interest from an upright pose to a lying pose. Since the object size and shape is determined in the segmentation and tracking module 204, the elongation of the shape can be easily measured to distinguish a standing person from a lying person. With regard to the motion characteristics, the specific event detector module 210 preferably looks for a fast, downward motion of the object of interest. This is preferably measured either by computing optical flow and evaluating its direction, or by utilizing a motion energy receptor that evaluates motion and gives high response when it detects downward motion. The velocity can also be obtained from the optical flow, or from the response of the motion receptor. The “smoothness” of motion can also be used, for instance, a falling person doesn't fall half way, then stops, and then continues falling. With regard to the trajectories, the specific event detector module 210 preferably looks for abruptness in the trajectory of the tracked object of interest. A real fall (as opposed to a person lying on the floor (e.g. to exercise) is in some sense unexpected and would result in abrupt changes in the person's trajectory.

To detect the specific event, such as the fall-down event, one, a combination of, or preferably all of these characteristics are used as a basis for the occurrence or likelihood of occurrence of the specific event. Preferably, a temporal sequence sub-module (not shown) is provided to look for upright to lying transitions, a motion characteristics sub-module (not shown) is provided to look for a fast, downward motion, and a trajectory sub-module (not shown) is provided to look for an abrupt trajectory change. The outputs of these sub-modules are combined in any number of ways to detect the occurrence of the fall-down event. For example, each sub-module could produce a number between 0 and 1 (0 meaning nothing interesting observed, 1 meaning that the specific feature was almost certainly observed). A weighted average is then computed from these numbers and compared to a threshold. If the result is greater than the threshold, it is determined that the specific event has occurred. Alternatively, the numbers from the sub-modules can be multiplied and compared to a threshold.

Example sequences can be collected of people falling down, people lying down slowly, people simply moving around, etc. which are used to design and tune the combination of features from the sub-modules to determined the weights at which the factors from the sub-modules are combined, as well as the arithmetic operation for their combination, and the threshold which must be surpassed for detection of the occurrence of the specific event of interest. Similar techniques can be applied to other events, for example staggering can be detected by looking for motion back and forth, irregular motion, some abruptness, but without significant changes in body pose.

Similarly, panic gestures can be detected by looking for fast, irregular motions, especially in the upper half of the body (to emphasize the movement of arms) and/or by looking for irregular motions (as opposed to regular, periodic motions). In this way panic gestures can be distinguished from other non-panic movements, such as a person exercising vigorously. The speed of motion can be detected as described for the fall-down event. The irregularity of motion can be detected by looking for the absence of periodic patterns in the observed motion. Preferably, a sub-module is used to detect periodic motions and “invert” its output (by outputting 1 minus the module output) to detect the absence of such motions.

As discussed above, module 210 preferably looks for specific predefined events, such as a “fall-down” event. While designing a specific detector module 210 for each event may be time-consuming, this approach is feasible when a limited number of selected events need to be recognized. Since there is no requirement for using the same set of image features for each event, this further simplifies the design process.

### Learning of Events

An enormous number of different human activities can be observed in our daily life. To enable the system 100 to detect a wider set of abnormal events related to medical emergencies, a general framework is needed. Such a framework has to be able to learn and thus detect any event of interest, and not limited to the aforementioned specific events. This is the function of the learning of events module 208.

In general, events have a complex time-varying behavior. In order to model all these variations, a framework that is based on the Hidden Markov Model (HMM) is preferably used. MMM provides a powerful probabilistic framework for learning and recognizing signals that exhibit complex time-varying behavior. Each event is modeled with a set of sequential states that describes the paths in a high-dimensional feature space. These models are then used to analyze video sequences to segment and recognize each individual event to be recognized.

The topology preferred is a hierarchical HMM, which encompasses all possible paths with their corresponding intermediate states that constitute an event of interest. Take fall-down as an example. All fall-down events share two common states: start (when a person is in normal standing posture) and end (when the person has fallen down), but take multiple paths in-between start and end. By presenting the system with a large number of example sequences from a segmented video of a person falling down in various ways seen from different cameras, the system finds all representative paths and their corresponding intermediate states. Clustering techniques are applied in the feature space to determine splitting and merging of hidden states in the Markov graph. An exemplary hierarchical HMM topology is shown in FIG. 5.

In event learning, it is crucial to have an appropriate number of hidden states in order to characterize each particular event. The HMM framework starts with two hidden states (start and end). It then iteratively trains the HMM parameters using Baum-Welch cycles, and more hidden states can be automatically added one by one, until an overall likelihood criterion is met. To prevent the model from having too many overlapping states, Jeffrey's divergence, as discussed in Gray, Entropy and Information Theory, Springer-Verlag, 1990, is used to measure the separation between two consecutive states. A similar learning framework has been used for learning facial expressions and has obtained very promising results, as shown in Colmenarez et al., Modeling the Dynamics of Facial Expressions, Submitted to Workshop in Cues and Communication, Computer Vision and Pattern Recognition, Hawaii, USA, 2001.

Furthermore, selecting features that can capture the spatio-temporal characteristics of an event in any time instant is preferably utilized. Features (or observation vectors) associated with each state can take any of (or a combination of) the following forms: visual appearance (e.g., image data, silhouette), motion description (e.g., the level of motion in different parts of the human body), body posture (e.g., standing, sitting, or lying), and view-invariant features.

Behavior Analysis

Another preferred component of the monitoring system 100 of the present invention is behavior analysis as carried out by module 211. The goal of behavior analysis is to identify what the usual patterns of behavior of the person of interest 106 at module 212 and to detect the unusual changes in behavior and/or the absence of ordinary patterns at module 214 (too short or too long sleep, not eating regularly or not eating at all, etc). Behavior analysis requires the modeling of human behavior at module 212, such as by means of analysis of human trajectories, or the combination of activities and trajectories, and abnormal behavior reasoning at module 214, such as by means of detection of “unusual” trajectories.

In the broader sense, the analysis of human behavior can be classified into two types of tasks: analysis of human activities and analysis of human trajectories.

In this section, we will describe in more detail the analysis of human trajectories and the combination of activities and trajectories.

Most methods for analysis of human behavior consist of the following three steps: object tracking, trajectory learning (performed a priori) and trajectory recognition. It is known in the art to use statistical learning techniques to cluster object trajectories into descriptions of normal scene activities. The algorithms have been used to recognize different trajectories in the outdoor environment, such as that disclosed in Johnson et al., Learning the distribution of object trajectories for Event Recognition, Proc. British Machine Vision Conference, pp. 583-592, 1995 and Stauffer et al., Learning patterns of activity using real time tracking, IEEE Trans. Pattern Analysis and Machine Intelligence, 22(8): 747-757, 2000.

It is also known to use a Condensation algorithm for object tracking, and clustered object trajectories into prototype curves, such as that disclosed in Koller-Meier et al., Modeling and recognition of human actions using a stochastic approach, Proc. Advanced Video-Based Surveillance Systems, pp. 17-28, 2001; Isard et al., Condensation—conditional density propagation for visual tracking, International Journal Computer Vision, 1998. During the recognition stage, a Condensation tracker is used for both object tracking and the recognition of the object trajectory.

It is still further known in the art to use an entropy minimization approach to estimate HMM topology and parameter values, such as that disclosed in Brand et al., Discovery and segmentation of activities in video, IEEE Trans. Pattern Analysis and Machine Intelligence, 22(8): 844-851, 2000. Such an entropy minimization approach simultaneously clusters video sequences into events and creates classifiers to detect those events in the future. The entropy minimization approach has been successfully demonstrated with models of office activities and outdoor traffic, showing how the framework learns principal modes of activity and patterns of activity change.

In light of the above-mentioned observations, the following approach is used for the analysis of human behavior in the system 100 of the present invention:

Using tracking and posture analysis techniques, compute the person's position and posture at each frame of the video sequence.

Compute the level of body motion, through optical flow, motion history, or other motion estimation technique (the level of body motion is defined as the amount of motion a person is producing while remaining in the vicinity of the same physical location).

Compute a probability density function (pdf) for modeling the person's behavior. The pdf captures a five dimensional space (2D location in the home, time, posture and a level of body motion).

Develop a knowledge-based description of certain behaviors and recognizing them from the pdf. For example, people usually sleep at night, and therefore a cluster with a pre-specified time (i.e., several hours during the night), posture (i.e., lying) and activity (i.e., low level of body motion) can be labeled as sleeping. Moreover, from this description the location of the person's bed in the house can be inferred.

Understand behavior, i.e., understand which habits are repeated on daily basis, and detect their absence.

In a preferred implementation, the system and methods of the present invention can also look at the elderly person in a holistic way: it can obtain biomedical data (like heart rate and blood pressure), it can observe his/her actions (e.g. notice if he/she falls down or forgets to take his/her medicine), it looks for changes in his/her routine behavior (e.g. slower movements, skipping of meals, staying in bed longer) and it interacts with him/her (e.g. by asking if he/she hurt herself during a fall). An inference engine, taking into account all these inputs, decides if an alarm is needed or not.

Those skilled in the art will appreciate that the automatic monitoring system of the present invention, installed in the vicinity, such as a home, of certain classes of people, such as the elderly, physically handicapped, or mentally challenged, would be a solution to the problems associated with the prior art. It would continuously check on them and, if a problem arises, send an alarm to a family member or a service organization, who could then dispatch medical or other emergency help. Since the system 100 of the present invention allows people to continue living in their own home, its cost is much lower and allows more independence than the nursing home or assisted living alternatives. Current monitoring systems typically require the person to wear some device. This is often resisted, as it is a constraint on freedom and a constant reminder of no longer being able to take care of oneself. To gain acceptance by the elderly, non-intrusive sensors are therefore needed. Among such sensors, cameras are most useful, since they provide rich data which, when properly analyzed, gives the system a variety of information about the state of the person.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method for monitoring a person of interest in a scene, the method comprising:
capturing image data of the scene;
detecting and tracking the person of interest in the image data;
analyzing features of the person of interest; and
detecting at least one of an event and behavior associated with the detected person of interest based on the features; and
informing a third party of the at least one detected event and behavior.

2. The method of claim 1, wherein the person of interest is selected from a group comprising an elderly person, a physically handicapped person, and a mentally challenged person.

3. The method of claim 2, wherein the detecting of at least one of an event and behavior detects at least one of an abnormal event and abnormal behavior.

4. The method of claim 2, wherein the scene is a residence of the person of interest.

5. The method of claim 1, wherein the detecting and tracking comprises segmenting the image data into at least one moving object and background objects, the at least one moving object being the person of interest.

6. The method of claim 5, wherein the detecting and tracking further comprises:
learning and recognizing a human shape; and
detecting a feature of the moving object indicative of a person.

7. The method of claim 6, wherein the detecting of a feature of the moving object indicative of a person comprises detecting a face on the moving object.

8. The method of claim 3, wherein the detecting of abnormal events comprises:
comparing the analyzed features with predetermined criteria indicative of a specific event; and
determining whether the specific event has occurred based on the comparison.

9. The method of claim 8, wherein the specific event is selected from a group comprising a fall-down, stagger, and panic gesturing.

10. The method of claim 8, wherein the analyzing comprises analyzing one or more of a temporal sequence of the person of interest, a motion characteristics of the person of interest, and a trajectory of the person of interest.

11. The method of claim 8, wherein the determining step comprises assigning a factor indicative of how well each of the analyzed features comply with the predetermined criteria indicative of the specific event and applying a arithmetic expression to the factors to determine a likelihood that the specific event has occurred.

12. The method of claim 3, wherein the detecting of abnormal events comprises modeling a plurality of sample abnormal events and comparing each of the plurality of sample abnormal events to a sequence of the image data.

13. The method of claim 3, wherein the detecting of abnormal behavior comprises:
computing a level of body motion of the person of interest based on the detected tracking of the person of interest;
computing a probability density for modeling the person of interest's behavior;
developing a knowledge-based description of predetermined normal behaviors and recognizing them from the probability density; and
detecting the absence of the normal behaviors.

14. The method of claim 3, wherein the informing comprises sending a message to the third party that at least one of the abnormal event and abnormal behavior has occurred.

15. The method of claim 14, wherein the sending comprises generating an alarm signal and transmitting the alarm signal to a central monitoring station.

16. The method of claim 14, wherein the sending comprises transmitting at least a portion of the captured image data to the third person.

17. A system for monitoring a person of interest in a scene, the system comprising:
at least one camera for capturing image data of the scene;
a processor operatively connected for input of the image data for: and
detecting and tracking the person of interest in the image data;
analyzing features of the person of interest;
detecting at least one of an event and behavior associated with the detected person of interest based on the features; and
informing a third party of the at least one detected event and behavior.

18. A computer program product embodied in a computer-readable medium for monitoring a person of interest in a scene, the computer program product comprising:
computer readable program code means for capturing image data of the scene;
computer readable program code means for detecting and tracking the person of interest in the image data;
computer readable program code means for analyzing features of the person of interest; and
computer readable program code means for detecting at least one of an event and behavior associated with the detected person of interest based on the features; and
computer readable program code means for informing a third party of the at least one detected event and behavior.

19. A program storage device readable by machine, tangibly embodying a program of instructions executable by the machine to perform method steps for monitoring a person of interest in a scene, the method comprising:
capturing image data of the scene;
detecting and tracking the person of interest in the image data;
analyzing features of the person of interest; and
detecting at least one of an event and behavior associated with the detected person of interest based on the features; and
informing a third party of the at least one detected event and behavior.
